(19) United States
(12) Patent Application Publication
(10) Pub. No.: US 2010/0061464 A1
(43) Pub. Date: Mar. 11, 2010

(54) MOVING PICTURE DECODING APPARATUS AND ENCODING APPARATUS

(75) Inventor: Yasuhiro Watanabe, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED, Kawasaki (JP)

(21) Appl. No.: 12/400,545

(22) Filed: Mar. 9, 2009

(30) Foreign Application Priority Data
Jun. 3, 2008 (JP) 2008-146185

(51) Int. Cl. H04N 7/26

(52) U.S. Cl. 375/240.24; 375/E07.2

(57) ABSTRACT

When picture data is stored in memory units 0 through 3 and image decoding units 0 through 3 decode the data in parallel, a picture having macroblock lines 0 through 134 is divided into four areas and stored in the memory units 0 through 3. The area in a picture assigned to each image decoding unit is fixed by allowing the image decoding unit 0 to constantly take charge of the macroblock lines 0 through 3 of each picture. The image decoding unit for taking charge of the process of an area at a lower portion of a picture shifts the process timing on the same picture so that the same assigned area of the picture can be processed after the completion of the process of another image decoding unit taking charge of the area above the area assigned to the image decoding unit taking charge of the lower area.

### CROSS-REFERENCE TO RELATED APPLICATION

This application is based upon and claims the benefit of priority of the prior Japanese Patent Application No. 2008-146185, filed on Jun. 3, 2008, the entire contents of which are incorporated herein by reference.

### FIELD

The present invention relates to a moving picture decoding apparatus and encoding apparatus.

### BACKGROUND

With the widespread use of a high definition broadcast, a large capacity optical disk, etc., HDTV (high definition TV) images (1920×1080 pixels) have been more commonly processed. It is further studied to use UHDTV (ultra high definition TV) images (7680×4320 pixels) of a larger screen, and further enhancing the throughput of a decoding/encoding apparatus in an MPEG system is demanded.

To enhance the throughput, “improving an operation frequency”, “parallel processing”, etc. can be considered. However, to improve an operation frequency, it is necessary to improve processing technology, to obtain a circuit operable at a high speed, etc. On the other hand, since it is necessary to perform an inter-frame (picture) predicting process and a variable length decoding process for the parallel processing, an encoded and compressed bit stream is to be sequentially processed from the beginning. Therefore, it is hard to realize simple parallel processing, and there have been various devices for the parallel processing.

Conventional devices proposed as parallel processing methods are a method of intra-frame parallel processing in slice units using the independency of data in a frame such as a slice in the MPEG2, a method of inter-frame parallel processing to be performed after decoding data in a reference image area necessary in the inter-frame prediction for each macroblock (units in encoding and decoding data for a 16×16 pixel area) with the range of a motion vector taken into account, etc.

FIGS. 1A through 1C are explanatory views of the method of performing intra-frame parallel processing in slice units.

FIG. 1A illustrates the image decoding unit and the divided screen and the areas assigned to each unit. FIG. 1B illustrates operation timing. FIG. 1C illustrates the configuration of a block.

Used in the method illustrated in FIG. 1A is a unique code referred to as a slice header for each macroblock line in the MPEG2 standard. As illustrated in FIG. 1A, one screen is configured by 68 lines (slices), and when two image decoding units are used, one screen is divided into 34 slices and a process is assigned to each slice. A plurality of memory units are also provided. Memory units 0 through 2 store three divided screen parts.

As illustrated in FIG. 1B, an image decoding unit 0 takes charge of slices 0 through 33 of one screen, and an image decoding unit 1 takes charge of slices 34 through 67 of one screen. These assigned slices remain unchanged although a different picture is processed. That is, as illustrated in FIG. 1B, when the image decoding unit 0 processes a picture I0, the unit processes the slices 0 through 33, and also processes slices 0 through 33 when the next picture P3 is processed. Similarly, when pictures B1 and B2 are processed, the image decoding unit 0 takes charge of the slices 0 through 33. On the other hand, the image decoding unit 1 processes the slices 34 through 67 in parallel with the image decoding unit 0. The same holds true with the subsequent pictures P3, B1, and B2. The processes of the slices 0 through 33 by the image decoding unit 0 and the concurrent processes of the slices 34 through 67 by the image decoding unit 1 are performed within 1/30 second as the processing time of one screen. The processing time of 1/30 second for one screen is defined when moving pictures are displayed by displaying 30 images per second.

As illustrated in FIG. 1C, a video stream is temporarily stored in a stream buffer 10, and read by the image decoding units 0 and 1. The data read from the stream buffer 10 is stored in the memory 0 through 2 through the image decoding units 0 and 1. Since the slice assigned and processed by the image decoding unit is different from the slice assigned and stored in memory as illustrated in FIG. 1A, the image decoding unit 0 has to access the memory 0 and 1 and the image decoding unit 1 has to access the memory 1 and 2. Since the data stored in the memory 0 through 2 is read again for processing by the image decoding units, it is necessary to provide a two-way access path between the image decoding units and memory. Therefore, selectors 11-1 through 11-3 are provided.

In a recent image compression standard such as H.264 etc., unlike the MPEG-2, there is not necessarily a unique code in a frame, and it is necessary to refer to an upper adjacent macroblock. Therefore, the technology of performing parallel processing at a slice level cannot be applied to a recent image compression standard represented by the H.264.

The method of performing inter-frame parallel processing by controlling to maintain the dependency of the inter-frame prediction can be used for the recent image compression standard including the H.264. However, when the method is applied to a large size image such as an UHDTV image etc., there occurs the following problem.

In a decoder/encoder for a large size image, the number of decoding/encoding blocks is increased in order to enhance the throughput. In addition, relating to a memory module for storing an image, a necessary memory capacity and a plurality of memory modules to reserve a bandwidth between the memory module and the decoding/encoding block are to be provided.

For example, with the configuration of using four decoding blocks and four memory modules, each decoding block takes charge of assigned frame processing, and each memory unit stores data of the assigned area. Four decoding blocks have to access all of four memory modules. Therefore, there has to be a 4-to-4 connection between the decoding block and the memory module, thereby generating a complicated and expanded memory bus configuration.

### SUMMARY

According to an aspect of the invention, the moving picture decoding apparatus includes: a plurality of memory units assigned different image areas and storing a predetermined image area of image data divided into a plurality of image areas for a plurality of pictures; a plurality of image decoding units assigned different image areas and performing an image decoding process on a predetermined image area of image data divided into a plurality of image areas for a plurality of pictures; and a connection means for controlling a connection between the plurality of memory units and the plurality of image decoding units.

The encoding apparatus according to the present invention includes: a plurality of memory units assigned different image areas and storing a predetermined image area of image data divided into a plurality of image areas for a plurality of pictures; a plurality of image encoding units assigned different image areas and performing an image encoding process on a predetermined image area of image data divided into a plurality of image areas for a plurality of pictures; and a connection means for controlling a connection between the plurality of memory units and the plurality of image encoding units.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A through 1C are explanatory views of a method for performing an intra-frame parallel processing in slice units;

FIGS. 2A and 2B illustrate the operations of a decoding process;

FIGS. 3A and 3B are explanatory views of a connection path between an image decoding unit and each memory module;

FIG. 4 is a view illustrating the upper write area in loop filter processing;

FIG. 5 is a view illustrating the relationship in position about the adjacent macroblock information required by each macroblock;

FIG. 6 is an explanatory view of the operation of the macroblock processing;

FIG. 7 is an explanatory view (1) of an intermediate data buffer;

FIG. 8 is an explanatory view (2) of an intermediate data buffer;

FIG. 9 is an explanatory view (3) of an intermediate data buffer;

FIG. 10 illustrates an example of a rectangular access;

FIG. 11 illustrates an example of a configuration of an access allocating module;

FIG. 12 is an explanatory view (1) of the decoder according to an embodiment of the present invention;

FIG. 13 is an explanatory view (2) of the decoder according to an embodiment of the present invention;

FIG. 14 is an explanatory view (3) of the decoder according to an embodiment of the present invention;

FIG. 15 is a process flow (1) according to an embodiment of the present invention;

FIG. 16 is a process flow (2) according to an embodiment of the present invention;

FIGS. 17A and 17B illustrate examples of configurations of a chip when the decoder configuration of an embodiment of the present invention is applied to an LSI;

FIGS. 18A through 18D illustrate assigning an image decoding unit and assigning a memory map when the embodiment of the present invention is applied as four parallel application to the H.264 decoder of 8K×4K pixels (7680×4320 pixels); and

FIG. 19 is a block diagram when the embodiment of the present invention is applied to an H.264 encoder.

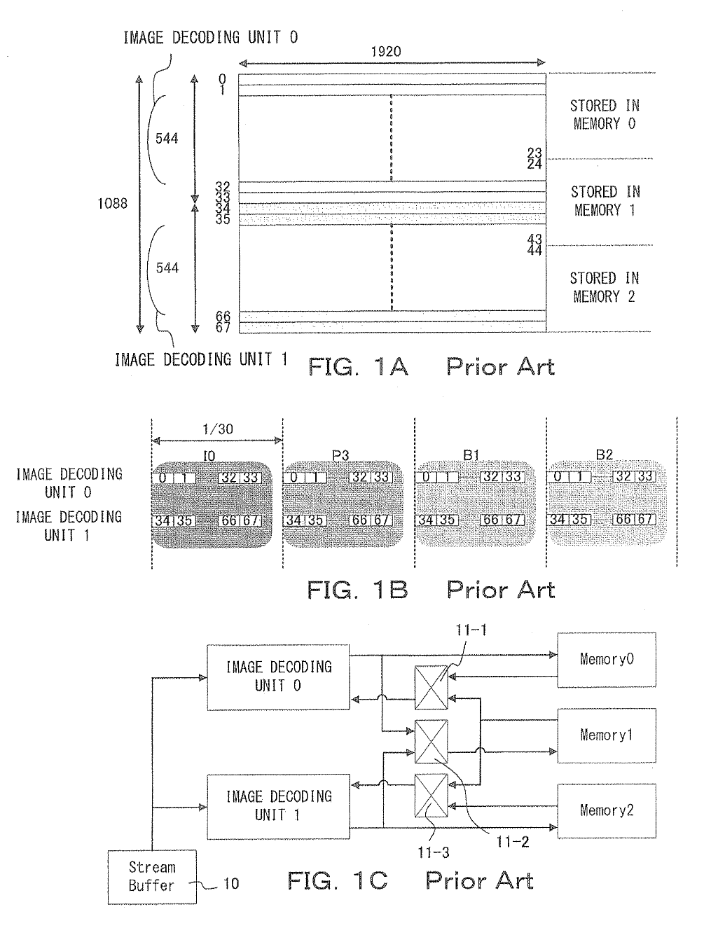

### DESCRIPTION OF EMBODIMENTS

The embodiments of the present invention relate to the configurations of the decoder and encoder devices of an image compression standard using inter-frame prediction such as the MPEG, the H.264, etc., and more specifically to the parallel processing method and configuration when a plurality of decoding/encoding blocks and a plurality of memory modules are used in a device requiring high throughput for decoding and encoding on a large size image of UHDTV images etc.

The moving picture decoding apparatus according to the embodiments of the present invention has a plurality of image decoding units and a plurality of memory modules for storing images decoded by the image decoding units. Each image decoding unit takes charge of the decoding process on each area obtained by dividing a picture into a plurality of areas, and each memory module is assigned a memory map for storing each area obtained by dividing a picture into a plurality of areas. The decoding process starting timing of each macroblock in each image decoding unit is the point after the completion of the decoding process on a reference image area required by a macroblock to be processed in the reference images required by the area assigned for the decoding process, and a memory access control unit has the function of selecting a data bus between memory modules storing areas to be used as reference images.

As a physical configuration of an image decoding unit and a memory module, there is a configuration of all image decoding units arranged on one chip, and a configuration of dividing it into a plurality of chips and arranging them. There can also be a configuration of a memory module as an external memory, and a configuration of an on-chip memory (embedded DRAM etc.).

In addition, each image decoding unit has an adjacent macroblock information buffer for storing adjacent macroblock information necessary for the decoding process. The adjacent macroblock information buffer can be accessed from two image decoding units that take charge of adjacent image areas. The adjacent macroblock information stored by one image decoding unit can be read by another image decoding unit.

An adjacent macroblock information buffer can be an internal buffer in a chip, or an area of external memory connected to a chip.

When a plurality of variable length decoding units and a plurality of image decoding units are provided, each variable length decoding unit takes charge of decoding process on pictures, and has an intermediate data buffer for storing decoded intermediate data output by the variable length decoding unit. Each image decoding unit of the decoded intermediate data stored in the intermediate data buffer has the function of recording a pointer to the storage position of a picture or each area in a picture assigned for the decoding process, and each of the image decoding units is assigned necessary decoded intermediate data for input.

The intermediate data buffer can be an internal buffer in a chip or memory external connected to a chip.

Furthermore, each image decoding unit has a device for a notification of a macroblock position information in the decoding process, and controls pause and resumption of a macroblock decoding process at an instruction from a control unit.

The control unit controls the decoding process starting timing so that a reference image area required by a macroblock to be processed can be completely decoded in the reference images required by the area assigned to each image decoding unit according to the macroblock position information notified from each image decoding unit. At this time, it is not necessary to set the unit of the pause and the resumption of each image decoding unit in macroblocks, that is, the unit of the pause and the resumption can be, for example, in macroblock line units.

Furthermore, a memory access allocation unit is provided between the image decoding unit and the memory module, and the memory access allocation unit has the function of allocating the access from the image decoding unit to any of a plurality of memory modules or a plurality of memory modules according to the memory map.

When a plurality of image decoding units are arranged as physically divided into a plurality of modules, all or a part of data of image data, adjacent macroblock information, decoded intermediate data, and macroblock decode position information are transmitted and received between the modules.

The moving picture encoding apparatus has a plurality of image encoding units and a plurality of memory modules for storing the local decoded images of the units. Each image encoding unit takes charge of an encoding process of each area obtained by dividing a picture into a plurality of areas, and each memory module is assigned a memory map storing each area obtained by dividing a picture into a plurality of areas. The encoding process starting timing of each macroblock in each image encoding unit is the point after the completion of the encoding process on a reference image area required by a macroblock to be processed in the reference images required by the area assigned for the encoding process. A memory access control unit selects a data bus between memory modules storing areas to be used as reference images. The basic configuration is the same as the configuration of the moving picture decoding apparatus.

In the present embodiment, the decoding process is started after completing decoding a reference image area required in referencing each macroblock. Therefore, the parallel processing can be performed at a picture level.

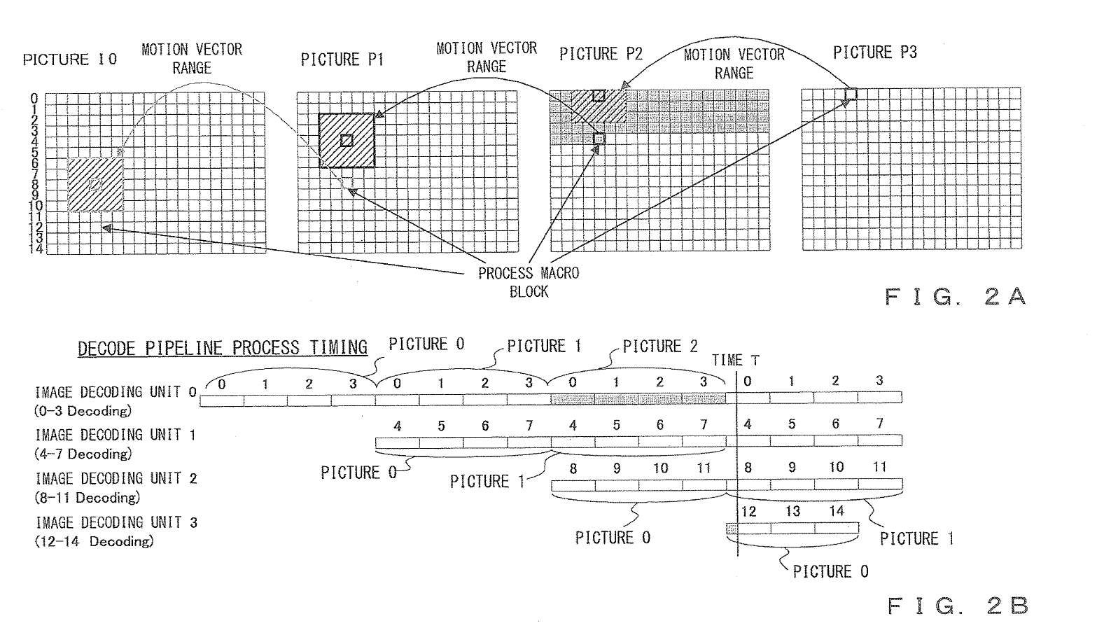

FIG. 2 illustrates the operation of the decoding process.

For example, the processing operation of each macroblock of the picture 1 is started after the macroblock processing of the reference enabled range of each macroblock is decode-completed. The image decoding unit 0 processes the upper ¼ of the entire picture, and the image decoding unit 1 processes the next ¼ of the entire picture. By the above-mentioned process assignment, it is necessary for each image decoding unit only to access the area assigned to each image decoding unit for the decoding process, and the reference image areas before and after the assigned area.

FIG. 2A illustrates pictures I0, P1, P2, and P3. The small square enclosed by bold lines refers to a macroblock to be processed (encoding and decoding unit block), and a large square refers to a range to be referenced when a macroblock to be processed is processed. When the macroblock to be processed of the picture P1 is processed, the range enclosed by the square with diagonals of the picture I0 is referenced. At this time, the macroblock to be processed of the picture P1 is processed after the process of the reference range of the picture I0 is completed. Similarly, the process of the macroblock to be processed of the picture P2 is performed after the process in the reference range of the picture P1 is completed, and the process of the macroblock to be processed of the picture P3 is performed after the process of the reference range of the picture P2 is completed.

FIG. 2B illustrates the concept of the process timing. The number of decoders to be provided is, for example, four. A decoder 0 decodes the slices 0 through 3 of one picture. A decoder 1 decodes the slices 4 through 7. A decoder 2 decodes the slices 8 through 11. A decoder 3 decodes the slices 12 through 14. First, the decoder 0 starts the process. When the decoder 0 completes the process on the slices 0 through 3 of the picture 0, it processes the slices 0 through 3 of the picture 1. Next, the decoder 0 processes the slices 0 through 3 of the picture 2. When the decoder 0 completes processing the slices 0 through 3 of the picture 0, the decoder 1 starts processing the slices 4 through 7 of the picture 0. When the decoder 1 completes processing the slices 4 through 7 of the picture 0, it starts processing the slices 4 through 7 of the picture 1. The decoder 2 starts processing the slices 8 through 11 of the picture 0 after the decoder 1 completes processing the slices 4 through 7 of the picture 0. The decoder 3 starts processing the slices 12 through 14 of the picture 0 after the decoder 2 completes processing the slices 8 through 11 of the picture 0.

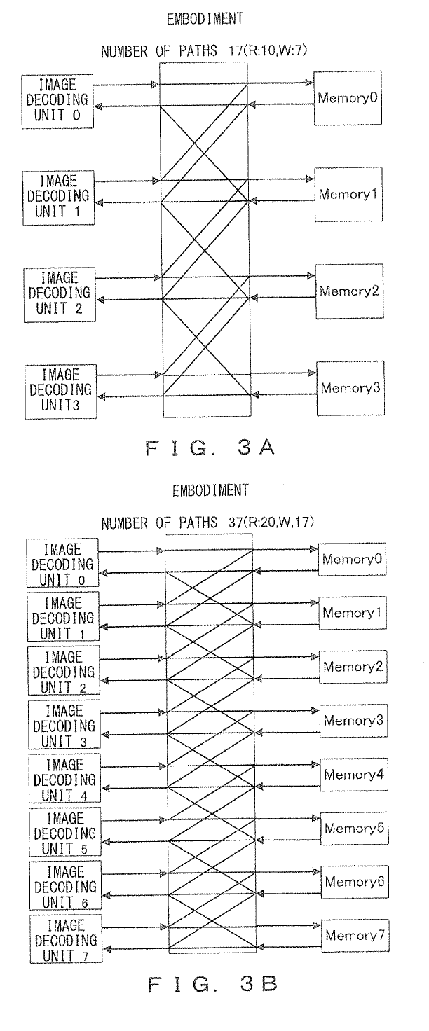

FIGS. 3A and 3B illustrate the states of the connection paths between the image decoding units (decoder core) and each memory.

An assigned decode area of each image decoding unit corresponds with an assigned storage area of each memory unit, and the reference image area required by the assigned decode area of each image decoding unit is stored in the corresponding memory and the memory units before and after the corresponding memory. That is, it is assumed that the maximum vector range of the motion vector to be referenced does not exceed the range of one memory storage area. In the method of allocating data to the image decoding unit and memory as described in the conventional technology, the numbers of connection paths are 32 and 128 with the respective configurations of the core 4/memory 4 and the core 8/memory 8 while the numbers according to the present embodiment are 17 and 37 respectively as listed as followed.

TABLE 1

| | NUMBER OF | | | NUMBER OF | | |
|---|---|---|---|---|---|---|
| | CONNECTION | | | CONNECTION | | |
| | PATHS | | | PATHS | | |
| | IN CONVENTIONAL | | | IN PRESENT | | |
| | TECHNOLOGY | | | EMBODIMENT | | |
| CONFIGURATION | Read | Write | TOTAL | Read | Write | TOTAL |
| Core4/Memory4 | 16 | 16 | 32 | 10 | 7 | 17 |
| Core8/Memory8 | 64 | 64 | 128 | 20 | 17 | 37 |

Relating to “write”, a write to the upper area in the current process area is required to perform loop filter processing in the H. 264.

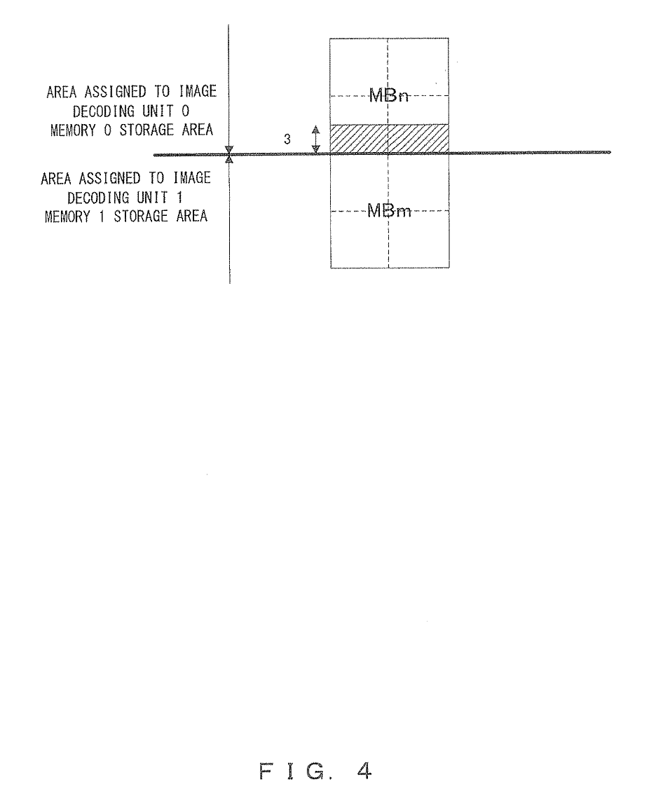

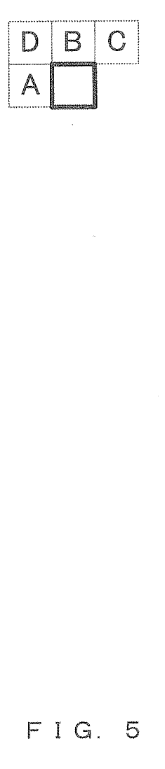

FIGS. 4 and 5 illustrate the upper write area in the loop filter processing.

In the loop filter processing, a read/write process on adjacent pixels of the process macroblock is required to perform filter processing on the block boundary not to generate a discontinuous portion of an image on the boundary between the macroblocks. When an upper adjacent macroblock is regarded, there is the possibility that three upper adjacent pixels can be changed in the loop filter processing in the H. 264 standard, thereby requiring the write processing on the three upper adjacent pixels.

As illustrated in FIG. 4, it is assumed that the macroblock MBn existing in the storage area of the memory 0 as a process assigned area of the image decoding unit 0 is adjacent to the macroblock MBm existing in the storage area of the memory 1 as a process assigned area of the image decoding unit 1. When the macroblock MBm is processed, the area in the MBn having the width of three pixels from the boundary is treated in the loop filter processing.

When the upper adjacency information is used in the decoding process as in the H. 264, it is necessary to pass the adjacent macroblock information from the image decoding unit processing the upper area to the image decoding unit processing the lower area. The adjacent macroblock information can be macroblock type information, the motion vector information, and a pixel value, etc. in each macroblock.

FIG. 5 illustrates the relationship in position about the adjacent macroblock information required by each macroblock in the decoding process.

When a macroblock is processed, the information about the adjacent A (left), B (upper), C (upper right), and D (upper left) is required. Since the macroblock process is performed by proceeding with the decoding process sequentially from the left, the adjacent macroblock information newly required to process a macroblock is C (upper right).

Described below is the operation of transmitting and receiving adjacency information using an adjacent macroblock information buffer. The adjacent macroblock information buffer has a capacity capable of storing the information for one macroblock line for each image decoding unit, divides into several N (the number of horizontal macroblocks) areas, and stores the macroblock information corresponding in a horizontal position to each area. The buffer is used not only in transmitting and receiving the information between the preceding and subsequent image decoding units, but also in the macroblock decoding operation in the image decoding units.

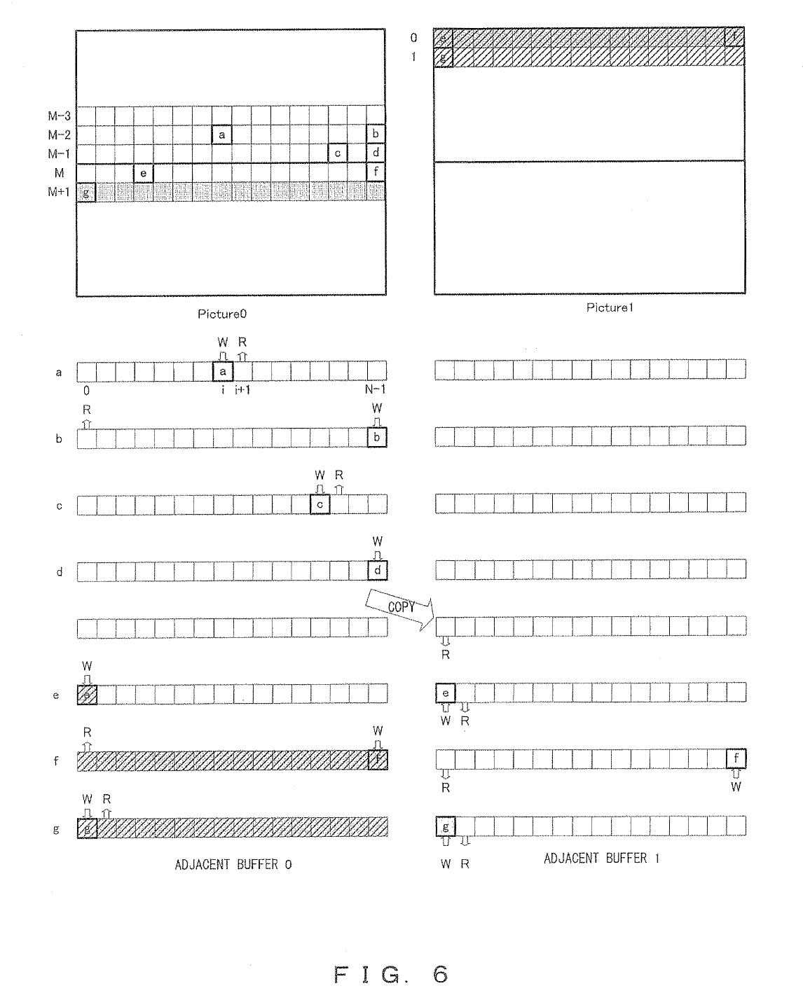

FIG. 6 is an explanatory view of the operation in the macroblock processing.

The macroblock lines 0 through M−1 perform a process by the image decoding unit 0 while the macroblock lines M through 2M−1 perform a process by the image decoding unit 1. When the macroblock at the position a of the macroblock line M−2 is to be processed, the macroblock information at the position C (upper right) of a is newly required. If the position a refers to the macroblock of the horizontal address i, then the macroblock information at the position C (upper right) is stored in the area i+1. Therefore, the information is read from the buffer area i+1 to perform the decoding process, and the macroblock information as a result of the current macroblock processing is written to the buffer area i. When the macroblock at the position b is processed, the information at the buffer position 0 is read to process the next macroblock line M−1, and the result of the current macroblock processing is written to the buffer area N−1. At this time point, the buffer is filled with the information about the macroblock line M−2. The macroblock line M−1 similarly proceeds with the process, but the macroblock information to be written is used by the image decoding unit 1. After the image decoding unit 0 performs the process at the last macroblock position d, the image decoding unit 0 processes the leading macroblock of the next picture. On the other hand, the image decoding unit 1 processes the macroblock at the horizontal position 0 of the macroblock line M. On the boundary, the data is copied from the adjacent macroblock information buffer of the image decoding unit 0 to the adjacent macroblock information buffer of the image decoding unit 1. After the copying process, the image decoding unit 1 reads the upper adjacent macroblock information, that is, the information about the macroblock line M−1, from the buffer of the image decoding unit 1, and writes the current macroblock information in the buffer of the image decoding unit 1. At this time, in the first macroblock processing (position e), the reading operation is performed on the adjacent B (upper area) and the adjacent C (upper right area). The image decoding unit 0 starts processing the macroblock line 0 of the next picture. Thus, by transmitting the adjacent macroblock information from the image decoding unit 0 to the image decoding unit 1, the decoding process assigned to each area of the picture can be taken over from the image decoding unit 0 to the image decoding unit 1.

The transmission and reception of the adjacent macroblock information between the image decoding unit 0 and the image decoding unit 1 can be performed in any method other than the above-mentioned method so far as the buffer is not overwritten. For example, there can be a method of the image decoding unit 0 writing its macroblock information after synchronous operations are performed in macroblock units and the information about the image decoding unit 0 (upper adjacency information) is read from the image decoding unit 1. In this case, in the period in which the image decoding unit 1 processes the macroblock line M, and the image decoding unit 0 processes the macroblock line 0 of the next picture (from the position e to the position f), the image decoding units 0 and 1 keeps in synchronization with each other and the buffer of the image decoding unit 0 reads data from the image decoding unit 1 and the image decoding unit 0 writes the data.

When control is passed to the macroblock line M+1, the adjacent buffers 0 and 1 write data at the leading position (position g), and read data from the next position.

By the above-mentioned control, the adjacent macroblock information is transmitted and received between the image decoding units, thereby enabling the parallel processing of assigning an area obtained by dividing a picture to each image decoding unit to be successfully performed.

It is necessary to perform the variable length decoding process by sequentially performing the processes from the head of the stream. The possible case of parallel processing is that there is no preceding or subsequent dependency before or after the variable length decoding process, and the parallel processing is performed by dividing a picture at a point where a boundary can be designated using a unique code etc. In the standard such as the H. 264 in which a slice division is not essential, the above-mentioned dividing position to be designated without fail is the boundary of a picture. Therefore, the parallel processing of the variable length decoding process is performed in picture units. On the other hand, an image decoding unit according to the present embodiment divides a picture into a plurality of areas and takes charge of the decoding process on the assigned area. With the configuration of the present embodiment, a decoded intermediate data buffer is provided between the variable length decoding unit and the image decoding unit, and a storage position pointer of the decoded intermediate data is recorded, thereby realizing the parallel processing by image decoding units.

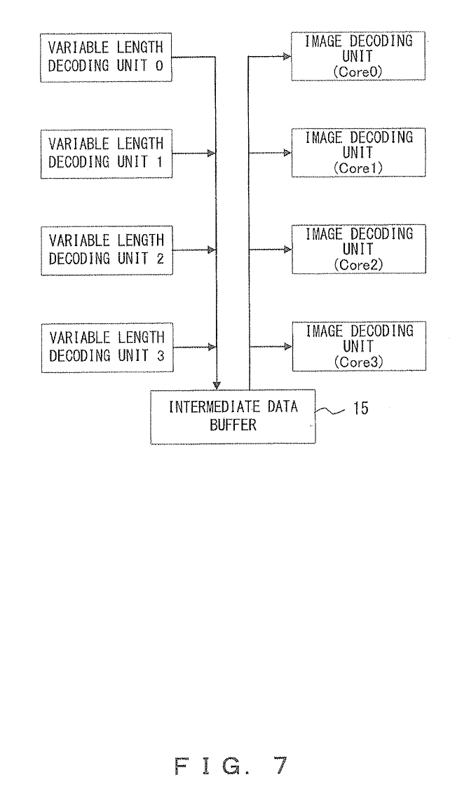

FIGS. 7 through 9 are explanatory views of the intermediate data buffer.

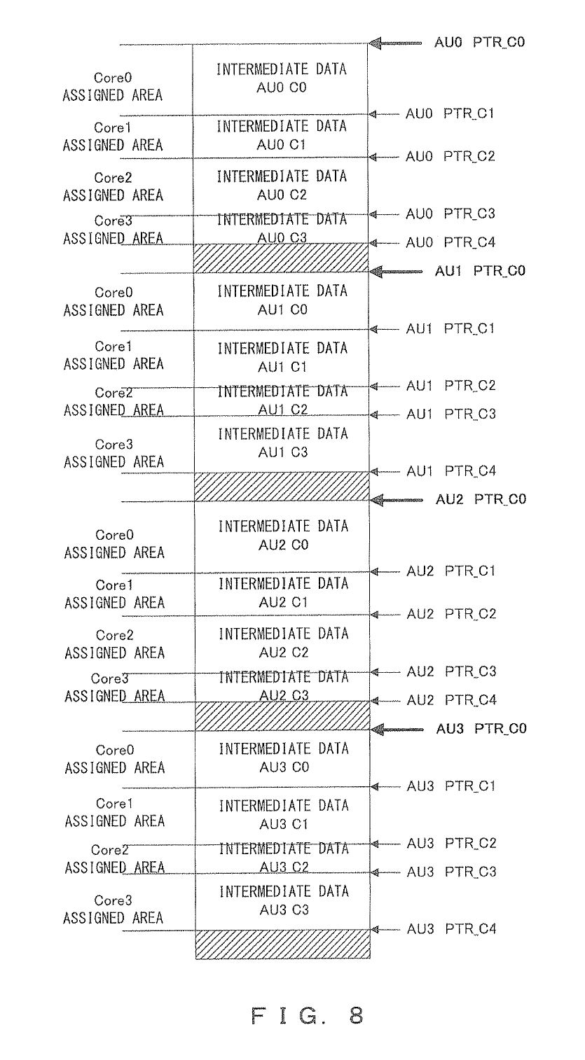

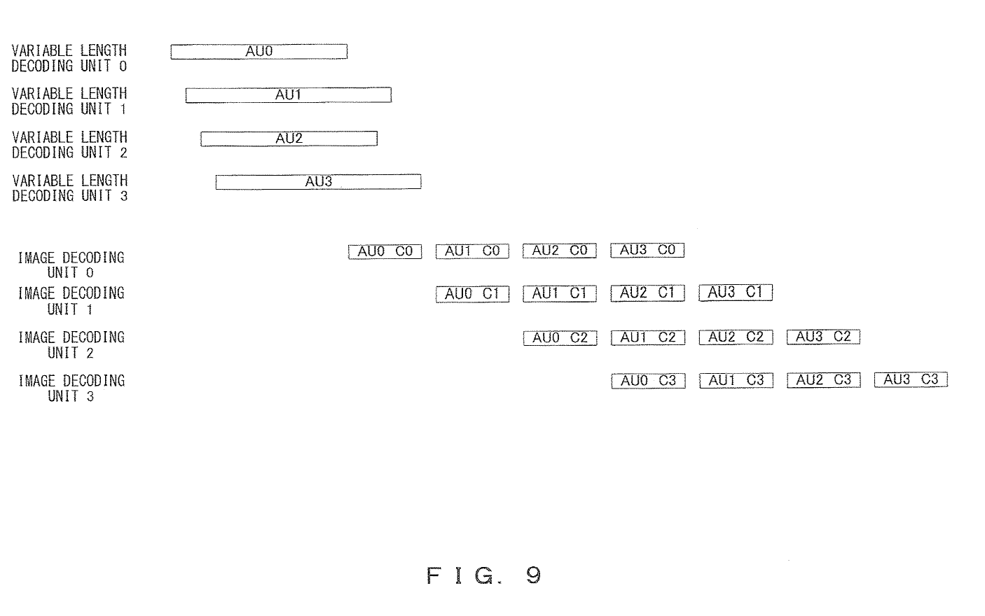

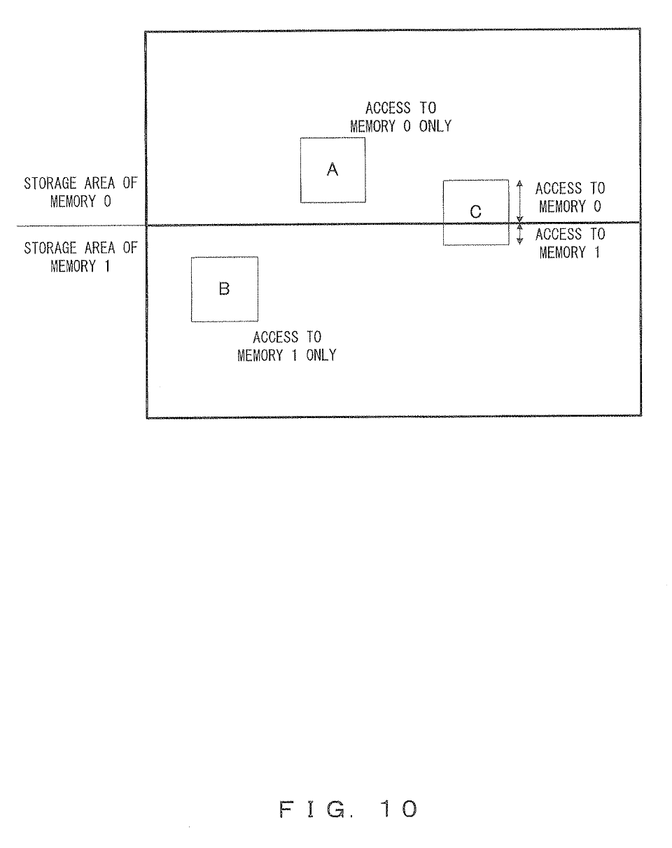

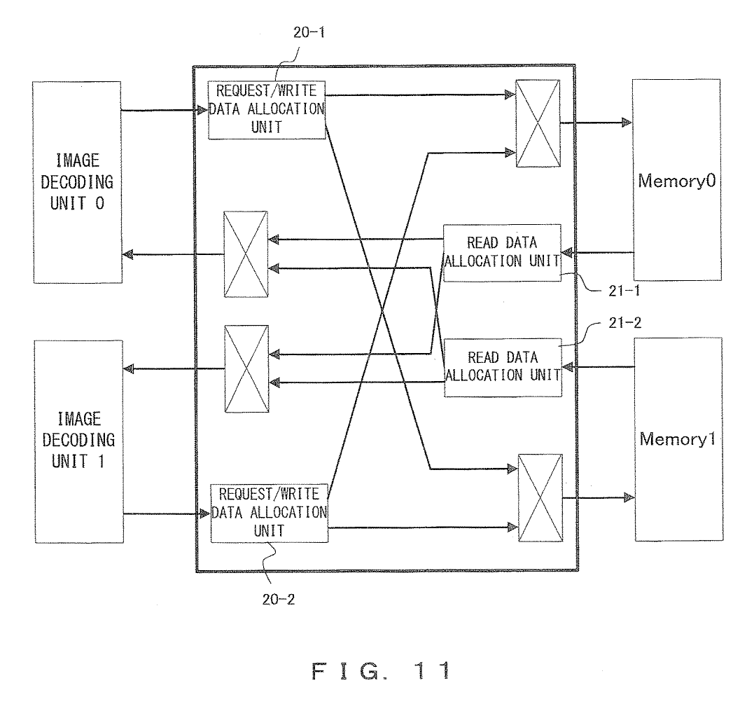

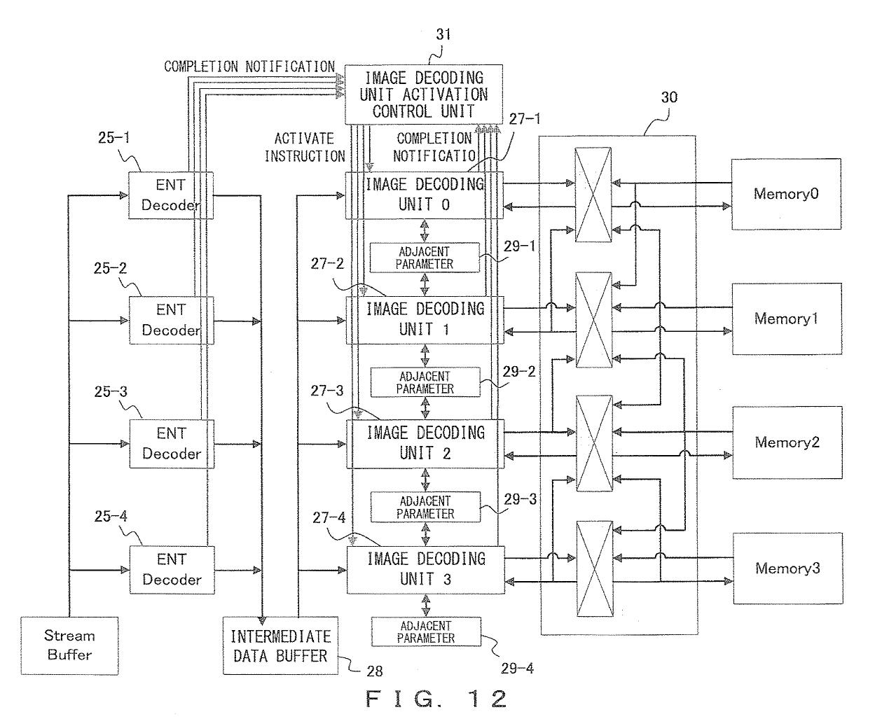

FIG. 7 illustrates the block diagram. FIG. 8 illustrates the relationship between the intermediate data buffer and the pointer. FIG. 9 illustrates the operation timing.

FIGS. 7 through 9 illustrate an example of the case when four variable length decoding units and four image decoding units are provided. The variable length decoding units 0 through 3 perform the process in picture units (for example, an access unit AU in the H. 264), and perform the decoding processes from AU0 to AU3 respectively. Then, the decoded intermediate data of each picture is stored in an intermediate data buffer 15, and the starting pointers (AU0 PTR_C0, AU1 PTR_C0, AU2 PTR_C0, and AU3 PTR_C0) are recorded. The image decoding unit 0 first reads the intermediate data indicated by the pointer of AU0 PTR_C0, and performs the decoding process. When the image decoding unit 0 completes the decoding process on the assigned area, it starts processing AU1 PTR_C0. At this time, the image decoding unit 1 starts the decoding process on the area assigned the AU0. The intermediate data of the area on which the image decoding unit 1 processes is continued from the intermediate data processed by the image decoding unit 0. Therefore, the process is started from the intermediate data process termination position (AU0 PTR_C1) of the image decoding unit 0. The pointer of AU0 PTR_C1 can be recorded by the variable length decoding unit during the intermediate data decoding process, and reported to the image decoding unit 1. Thus, by the image decoding units 0 and 1 performing the decoding process while reading the intermediate data of the area assigned to each of the units, the parallel processing operations can be performed. Similarly, the image decoding units 2 and 3 also perform the parallel processing. Thus, the storage area of the intermediate data processed by the image decoding unit can be determined and the parallel processing by each image decoding unit can be read by providing the intermediate data buffer 15 between the variable length decoding unit and the image decoding unit and recording and using the storage position pointer of the decoded intermediate data.

FIG. 8 illustrates an example of the contents of the intermediate data buffer 15. The data of each picture starts with the starting pointers (AU0 PTR_C0, AU1 PTR_C0, AU2 PTR_C0, and AU3 PTR_C0). The data assigned to the image decoding unit 0 are AU0 C0, AU1 C0, AU2 C0, and AU3 C0, and the respective pointers AU0 PTR_C1, AU1 PTR_C1, AU2 PTR_C1, and AU3 PTR_C1 indicate the end positions of the assigned data of the image decoding unit 0. These pointers also indicate the starting positions of the data assigned to the image decoding unit 1. Similarly, the data assigned to the image decoding unit 1, the image decoding unit 2, and the image decoding unit 3 are stored.

As illustrated in FIG. 9, the variable length decoding units 0 through 3 concurrently process the assigned data AU0 through AU3 respectively. The results of the processes are stored in the intermediate data buffer 15 illustrated in FIG. 7. In the image decoding units (cores) 0 through 3 illustrated in FIG. 7, the image decoding unit 0 first processes the first assigned data AU0 C0, then processes AU1 C0, thus sequentially processes the data. However, the image decoding unit 1 starts its process on AU0 C1 after the image decoding unit 0 completes the process on AU0 C0. Similarly, the image decoding unit 2 starts its process on AU0 C2 after the image decoding unit 1 completes the process on AU0 C1. The image decoding unit 3 starts its process on AU0 C3 after the image decoding unit 2 completes the process on AU0 C2.

By each image decoding unit notifying the control unit of the position information about the macroblock being processed, and the control unit being informed of the progress of the decoding process, the completion of the decoding process on the reference image area necessary for the reference in each macroblock can be recognized. If each image decoding unit can enter the pause state and resume the process in macroblock units at an instruction of the control unit, the decoding process can be started after necessary reference image areas are prepared in macroblock units. Normally, necessary reference image areas are regulated by the range of the vertical motion vector. Therefore, in a sense that the decoding process is started after all necessary reference image areas are prepared, the pause state and resumption can be controlled in macroblock line units.

However, when adjacency information is transmitted and received using the buffer storing the adjacent macroblock information described above, it is necessary to perform control so that the information about the upper adjacent macroblock written by the upper image decoding unit cannot be overwritten by the macroblock information about the next picture to be processed by the upper image decoding unit before it is read by the lower image decoding unit.

In the moving picture decoding process, the memory access such as a read of a reference image etc. is normally performed in a rectangular area on the image. When the image data of one picture is stored in each area, there can be a case where one rectangular access request spans two memory units in the boundary area. Therefore, it is necessary to divide the rectangular access request into two parts depending on the memory map.

FIG. 10 illustrates an example of a rectangular access.

The access in the area A is performed only in the memory 0. The access in the area B is performed only in the memory 1. However, since the area C has the upper memory 0 and the lower memory 1, it is necessary to access both memory units.

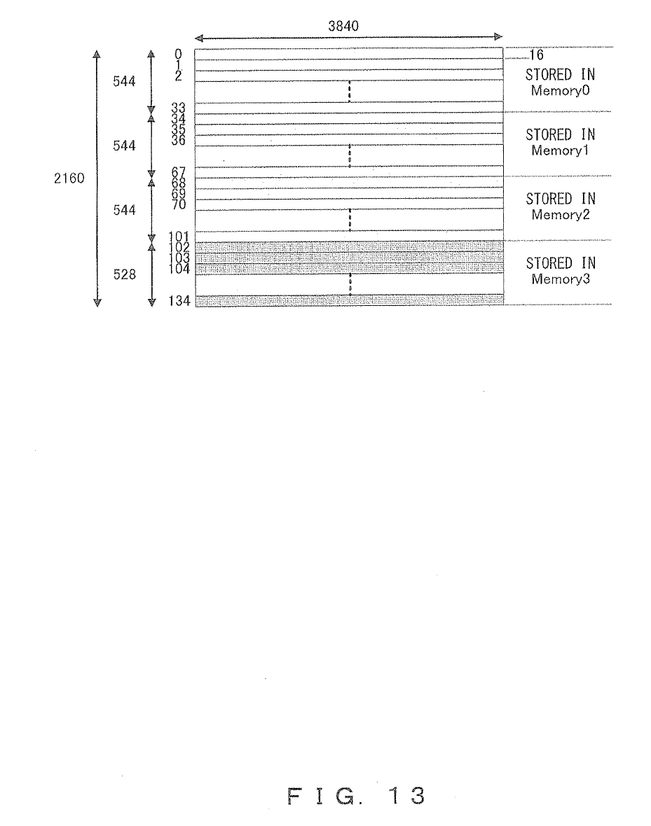

FIG. 11 illustrates an example of a configuration of an access allocating module.

During read access, request/write data allocation units 20-1 and 20-2 determine which memory is to be accessed or whether or not it is necessary to divide a request. When one memory unit is to be accessed, read access to the memory is performed. When it is necessary to divide a request, necessary read access for each memory unit is performed. The read data from each memory unit is returned to the image decoding unit as a request source depending on read data allocation units 21-1 and 21-2 determining as to which image decoding unit has issued the request.

During write access, request/write data allocation units 20-1 and 20-2 determine which memory is to be accessed or whether or not it is necessary to divide a request. When write data is received from an image decoding unit, and one memory unit is to be accessed, write access to the memory is performed. When it is necessary to divide a request, the write data received from the image decoding unit is allocated to each memory unit, thereby performing write access.

In the decoder according to the embodiment above, a plurality of image decoding units can be arranged as physically separated in a plurality of modules. In this case, all or a part of image data, adjacent macroblock information, decoded intermediate data, and macroblock decoding position information is transmitted and received between the modules. Thus, when a plurality of modules configure one decoder device, the inter-module IF and the amount of transferred data can be reduced by reducing the connection paths between the memory and image decoding units according to the present embodiment.

In the present embodiment, each image decoding unit is only to access at most two or three memory units. Therefore, although the number of image decoding units and memory units increases, the interconnection is restricted. Therefore, the relationship between the I/O terminal and the image decoding unit can be simplified in arrangement.

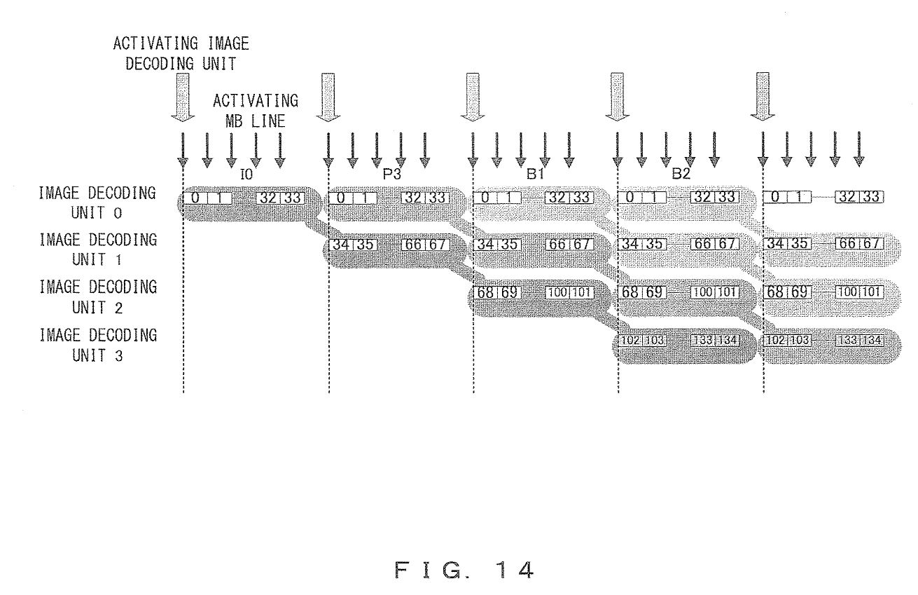

FIGS. 12 through 14 are explanatory views of the decoders according to the present embodiment.

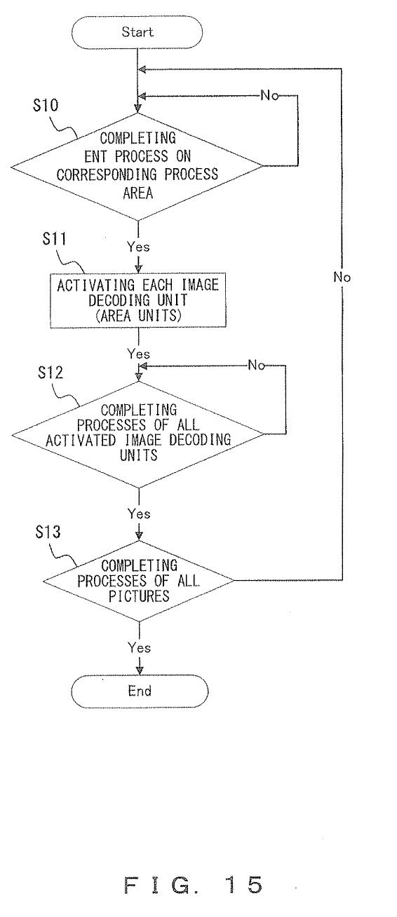

FIG. 12 illustrates the configuration of the block diagram of the device applied by four parallel arrangements of the present embodiment to the H. 264 decoder of 4K×2K (3840×2160 pixels). Four variable length decoding units 25-1 through 25-4 and four image decoding units 27-1 through 27-4 are provided. The variable length decoding units 25-1 through 25-4 perform parallel processing in picture units, and the image decoding units 27-1 through 27-4 take charge of the respective areas obtained by dividing one picture into four areas as illustrated in FIG. 13. The data of four areas is stored in four memory units. The vertical vector range in the present embodiment is ±512, and it is assumed that the area referred to by the area processed by each image decoding unit does not exceed the area processed by the upper and lower image decoding units. Each variable length decoding unit perform a variable length decoding process such as CAVLC, CABAC, etc. in accordance with the H. 264, and the image decoding units perform image decoding process of the H. 264 such as inverse quantization, inverse transformation, inter-prediction compensation, intra-prediction compensation, deblocking filter, etc. An intermediate data buffer 28 for storing intermediate data is provided between the variable length decoding units 25-1 through 25-4 and the image decoding units 27-1 through 27-4. Adjacent macroblock information buffers 29-1 through 29-4 for transmitting and receiving adjacent macroblock information are provided between the image decoding units. A memory control unit 30 having the function of allocating memory access and an image decoding unit activation control unit 31 for receiving process macroblock position information from each image decoding unit and performing activation control of each image decoding unit are provided between the image decoding units and the memory.

As illustrated in FIG. 13, the image data of one picture is divided into four memory units 0 through 3 and stored. The memory 0 stores macroblock lines 0 through 33, the memory 1 stores macroblock lines 34 through 67, the memory 2 stores macroblock lines 68 through 101, and the memory 3 stores macroblock lines 102 through 134.

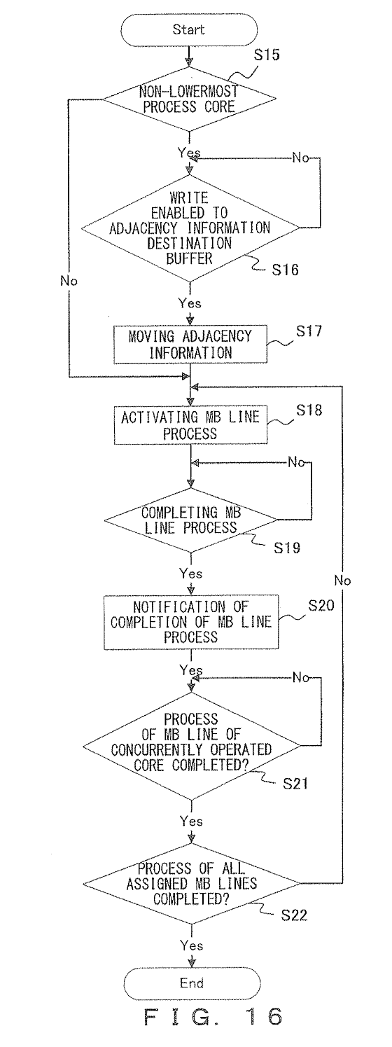

FIG. 14 illustrates the timing of the parallel processing operation.

The intermediate data buffer 28, the adjacent macroblock information buffers 29-1 through 29-4, the memory control unit 30, and the image decoding unit activation control unit 31 perform the respective functions described above, and realize the parallel processing operation in the H. 264 decoding process.

In FIG. 14, the image decoding unit 0 takes charge of the macroblock lines 0 through 33. The image decoding unit 1 takes charge of the macroblock lines 34 through 67. The image decoding unit 2 takes charge of the macroblock lines 68 through 101. The image decoding unit 3 takes charge of the macroblock lines 102 through 134. When the image decoding units are activated and the process on the first picture I0 is started, the image decoding unit 0 sequentially performs the processes on the macroblock lines 0 through 33. The process on each macroblock line is started by the activation of the process of a macroblock line performed for the process of each macroblock. When the processes on the macroblock lines 0 through 33 of the picture I0 is completed, the image decoding unit 0 performs the processes on the macroblock lines 0 through 33 of the next picture P3, and then sequentially processes the pictures B1, B2, . . . . After the completion of the processes on the macroblock lines 0 through 33 of the picture I0 of the image decoding unit 0, the image decoding unit 1 starts processing the macroblock lines 34 through 67 of the picture I0. After the image decoding unit 1 completes processing the macroblock lines 34 through 67, the image decoding unit 2 starts processing the macroblock lines 68 through 101 of the same picture. After the image decoding unit 2 completes processing the macroblock lines 68 through 101, the image decoding unit 3 starts processing the macroblock lines 102 through 134 of the same picture.

Described below is an example of the decoding process starting timing of each macroblock in each image decoding unit falling after completing the decoding process on the area of the reference image required by a macroblock to be processed in the reference images required by the area assigned for the decoding process.

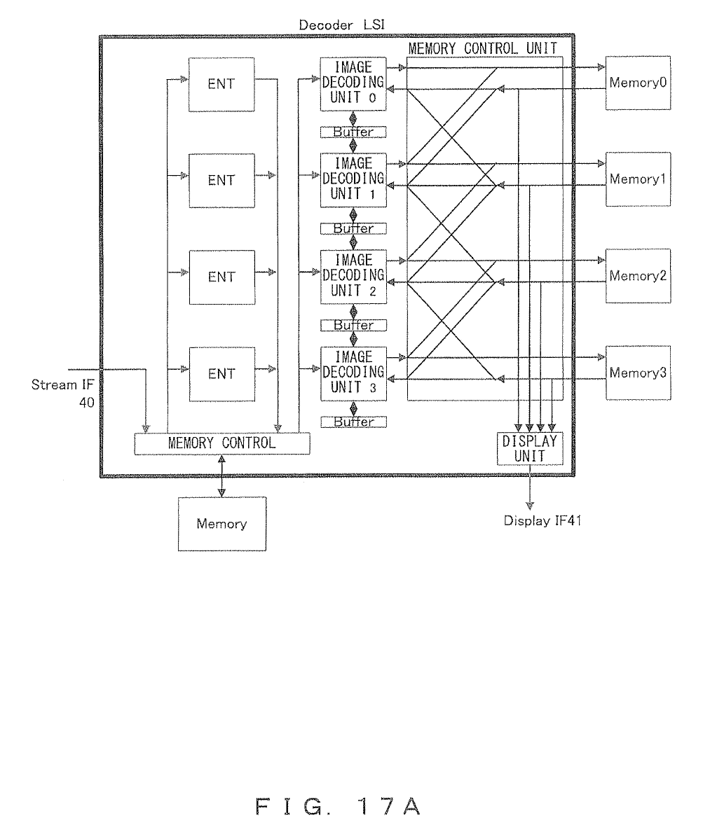

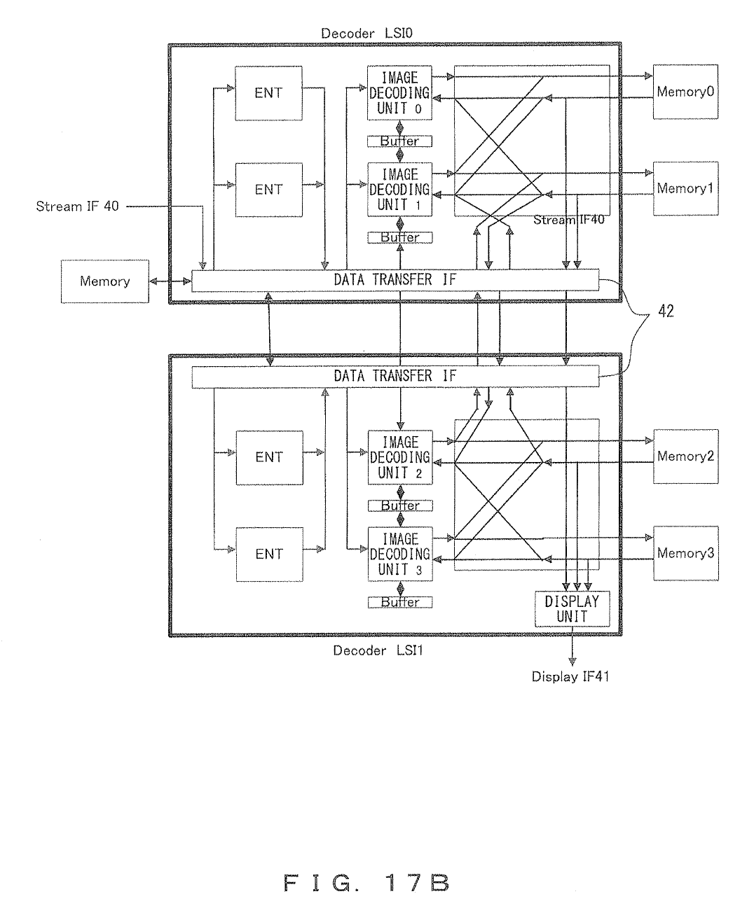

FIGS. 15 and 16 are process flowcharts according to the present embodiment.

FIG. 15 illustrates the activating process in area units. FIG. 16 illustrates the control of the activating process in macroblock line units.

Each area of an image decoding unit is synchronously activated, and after the processes of the entire areas of the image decoding unit are completed, the next activation is performed. The activation of each image decoding unit in macroblock line units is also synchronously controlled between the image decoding units in macroblock line units.

When an area is activated, it is first confirmed whether or not the variable length decoding process on the picture to be processed has been completed. If the variable length decoding process has not been completed, the completion is awaited. If the process has been completed, the image decoding unit is activated. When the image decoding unit activation is first performed, only the image decoding unit 0 is activated. When the entire process of assigning the areas of the image decoding unit 0 is completed and the variable length decoding process is completed, the image decoding unit 0 and the image decoding unit 1 are activated. When the process of assigning the areas of both image decoding units 0 and 1 is completed, the image decoding units 0, 1, and 2 are activated. Next, the image decoding units 0, 1, 2, and 3 are activated. On the other hand, when the three activating operations before the process terminates are performed, only the image decoding units 1, 2, and 3 are activated, only the image decoding units 2 and 3 are activated, and only the image decoding unit 3 is activated. Under the control, the number of times of activating the image decoding units in the N picture decoding process is N+3.

The activation of decoding process of macroblock line of each image decoding unit is controlled so that the decoding process on the required reference area has been completed when the decoding process is started for a macroblock. In the flow of this process, the completion of the macroblock line process of a concurrently operating image decoding unit is awaited although the macroblock line process is completed on the current image decoding unit after macroblock lines are activated. In the present embodiment, the vertical size of the assigned area of each image decoding unit exceeds the vertical motion vector range (±512). Therefore, if each image decoding unit is synchronized in macroblock line units, undecoded area is not referenced. Basically, the process of the specified MB (current process MB line number+fixed value depending on the maximum vertical vector) of one image decoding unit ahead is to have been completed.

To avoid the overwrite in the adjacent macroblock information buffer, the contents of the adjacent macroblock information buffer are moved before starting the first macroblock line process assigned to each image decoding unit. It is not necessary to move the adjacent macroblock information about the lowermost image decoding unit 3, but the adjacent macroblock information is performed from the image decoding unit 2 to the image decoding unit 3, from the image decoding unit 1 to the image decoding unit 2, and from the image decoding unit 0 to the image decoding unit 1. At this time, to avoid the overwrite of information, it is necessary to move the information in the above-mentioned order.

The descriptions are given below with reference to the attached drawings.

FIG. 15 is a flowchart of activating an image decoding unit assignment area process. In step S10, the completion of the ENT process (variable length decoding process) of a corresponding process area is awaited. In step S11, each image decoding unit 1 is activated. The activation is performed in process area units. Assuming that the number of parallel image decoding units is k, the activation of the first k−1 times is performed by increasing the number of activated image decoding units one by one from the image decoding unit taking charge of the upper area. When the process terminates are performed, the activation of the last k−1 times is performed by decreasing the number of activated image decoding units one by one from the image decoding unit taking charge of the upper area. In step S12, it is determined in area units whether or not all activated image decoding units have been completely processed, and the completion of the process is awaited. In step S13, it is determined whether or not all pictures have been completely processed. If the process has not been completed, control is passed to step S10. If it has been completed, the process terminates.

FIG. 16 is a flowchart of activating the MB line process. In step S15, it is determined whether or not the process MB line is assigned to the image decoding unit not for the lowermost area. It is not necessary to move the adjacent buffer to the lowermost area of the image. If the determination in step S15 is NO, control is passed to step S18. If the determination in step S15 is YES, the state in which a write to the adjacency information destination buffer is enabled is awaited in step S16. In this example, when the contents of the adjacent information buffer are moved between the image decoding units, the movement of the buffer immediately below as the destination buffer has to be completed. Since it is not necessary to move the buffer at the lowermost on the image, a write can be performed immediately. In step S17, the adjacency information is moved and control is passed to step S18. In step S18, the MB line process is activated. In step S19, the completion of the MB line process is awaited. In step S20, the termination notification of the MB line process is performed. In step S21, the completion of the MB line process of the concurrently operated image decoding unit is awaited. To guarantee that the process of the MB line that can be used in reference by the next activated MB line has been completed, the completion of the MB line process of the concurrently operated image decoding unit is awaited. In step S22, it is determined whether or not all of the assigned MB line processes have been completed. When the determination in step S22 is NO, control is returned to step S15. If it is YES, the process terminates.

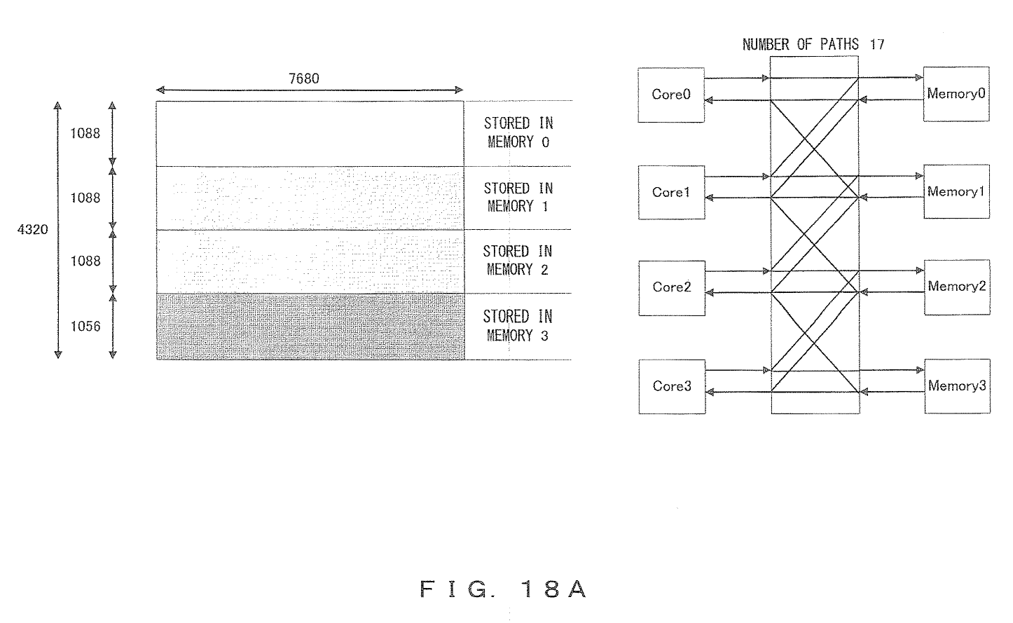

FIGS. 17A and 17B illustrate examples of the chip configurations of the decoder according to the present embodiment.

FIGS. 17A and 17B illustrate only an input interface (stream IF) 40 of decode stream used in the decoding process, and an image output interface (display IF) 41 for display of a decoded image. In the 1-chip configuration, four image decoding units are loaded into one chip, and four memory units for storing an image are connected. In these figures, the buffers for storing streams and intermediate data are configured by other memory units. The memory units can be provided separately from the four memory units for storing images, or can be used in the same memory by reserving an area in a part of the four memory units used for storing images. In the 2-chip configuration, a data transfer interface (data transfer IF) 42 is provided between two memory units to be able to transmit and receive stream data, intermediate data, adjacent macroblock information, image data, etc. Thus, when the image decoding unit is divided into a plurality of chips and the connection destination of the memory is divided into a plurality of chips, a data transfer is performed and the parallel processing according to the present embodiment is performed on the whole.

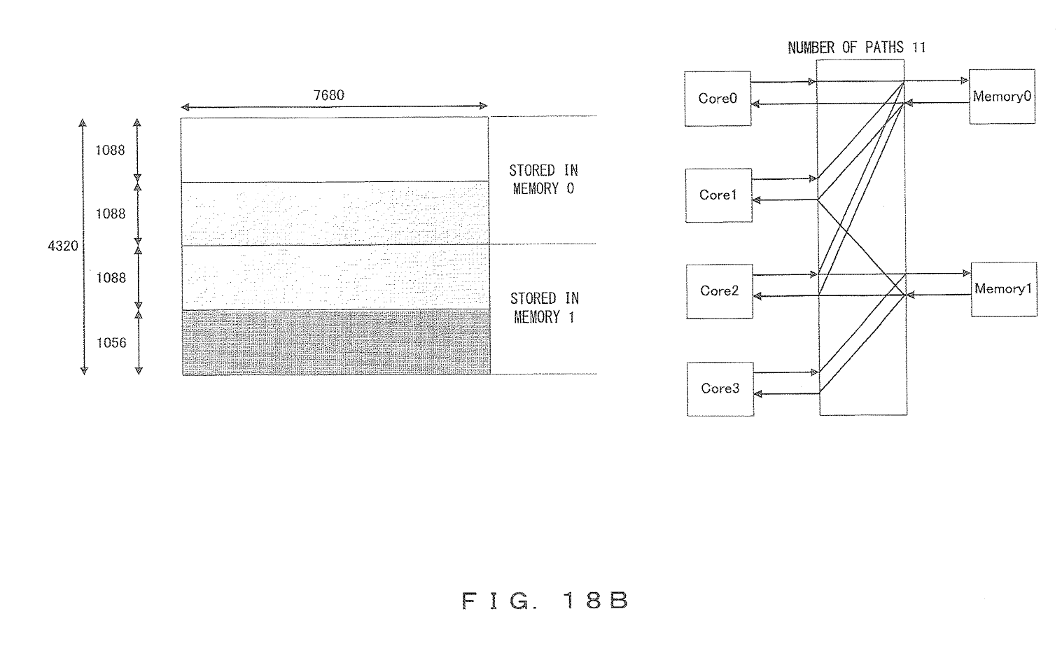

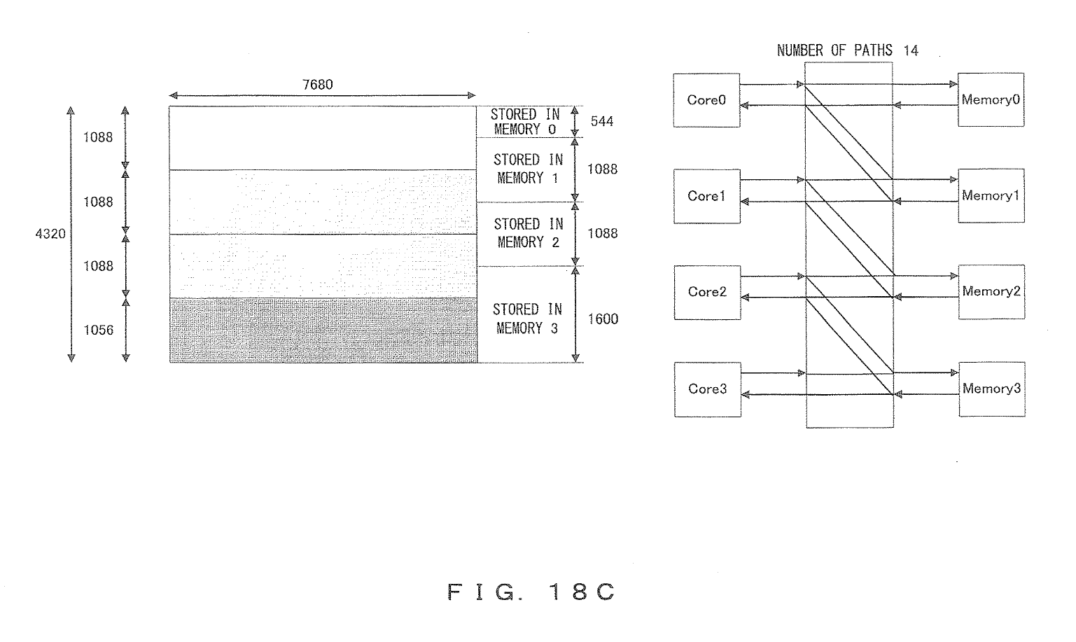

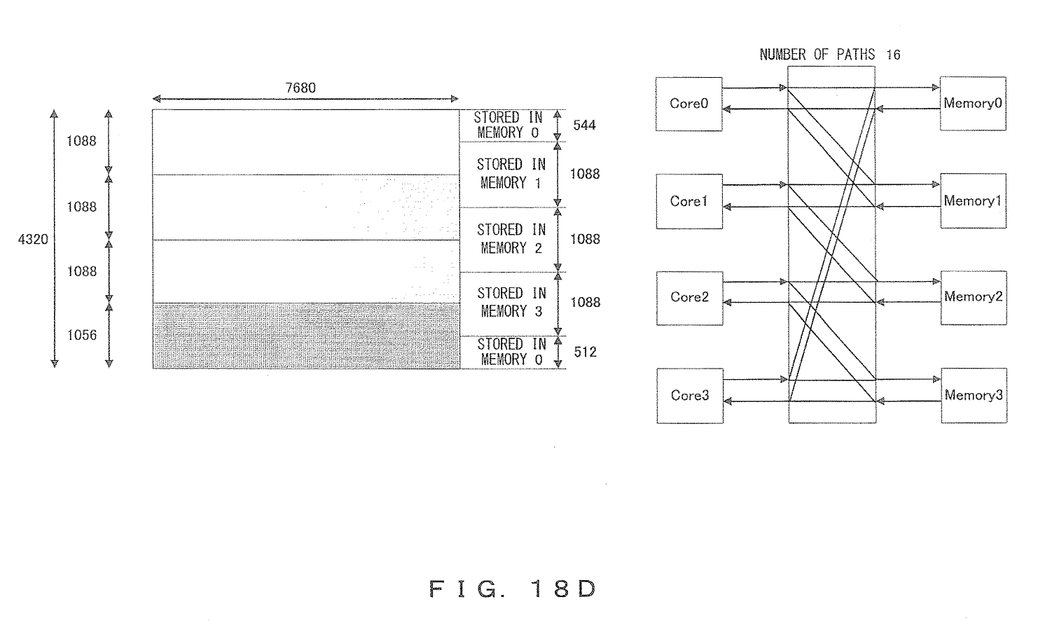

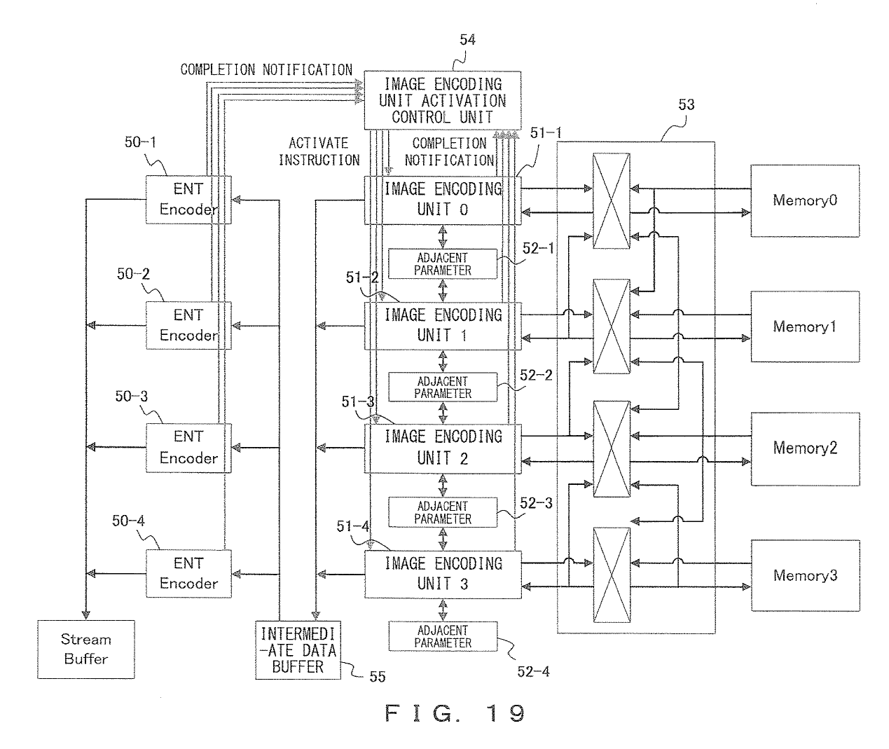

FIGS. 18A through 18D illustrate the assignment of an image decoding unit and a memory map when the present embodiment is applied to the decoder of 8K×4K pixels (7680×4320 pixels) as a 4-parallel application.

In the present embodiment, it is assumed that the vertical vector range is ±512. The data configuration is similar to that described above. FIG. 18A illustrates the case of a memory map in which four memory units are assigned to each of the area assigned to the four image decoding units. FIG. 18B illustrates the case of a memory map in which there are two memory units, that is, the assigned areas of the image decoding units 0 and 1 are assigned to the memory 0, and the assigned areas of the image decoding units 2 and 3 are assigned to the memory 1. FIG. 18C illustrates the case in which the assigned area of the image decoding unit is shifted by 544 lines from the assigned area of the memory map, that is, 544 lines are assigned to the memory 0 and 1600 lines are assigned to the memory 3. FIG. 18D illustrates the case in which, as illustrated in FIG. 18C, the assigned area of the image decoding unit is shifted by 544 lines from the assigned area of the memory map, that is, the lowermost 512 lines of the picture are assigned to the memory 0. The number of connection paths in each configuration is described below.

TABLE 2

| | NUMBER OF | | |
|---|---|---|---|
| | CONNECTION | | |
| | PATHS | | |
| CONFIGURATION | Read | Write | TOTAL |
| FIG. 18A | 10 | 7 | 17 |
| FIG. 18B | 6 | 5 | 11 |
| FIG. 18C | 7 | 7 | 14 |
| FIG. 18D | 8 | 8 | 14 |

In FIG. 18B, since the number of memory units is reduced to 2, the number of connection paths is also reduced. In FIGS. 18C and 18D, since the boundary between the area to be processed by the image decoding unit and the assigned area of the memory map is more largely separated than the vertical maximum value of the motion vector, the access from the maximum of two memory units has to be performed as read access. Therefore, the number of connection paths in the read is reduced than in the configuration illustrated in FIG. 18A. Including the assignment of these image decoding units and memory maps, the assignment of the areas of the image decoding unit in the picture and the assignment of the memory map can be realized in various methods.

FIG. 19 illustrates a device to which 4-parallel encoders of 4K×2K pixels (3840×2160 pixels) are applied. Four variable length encoding units 50-1 through 50-4 and four image encoding units 51-1 through 51-4 are provided. The variable length encoding units 50-1 through 50-4 perform the parallel processing in picture units, and the image encoding units 51-1 through 51-4 take charge of the respective areas obtained by dividing a picture into four areas. The data in the respective areas are stored in the four corresponding memory units. These assignments are performed as with the decoding device. Each of the variable length encoding units 50-1 through 50-4 performs the variable length encoding process such as CAVLC, CABAC, etc. in accordance with the H. 264 standard. The image encoding units 51-1 through 51-4 perform motion vector search, inter-prediction, intra-prediction, orthogonal transform, quantization, deblocking filter, etc. required in the image encoding process of the H. 264. An intermediate data buffer 55 for storing intermediate data is provided between the variable length encoding units 50-1 through 50-4 and the image encoding units 51-1 through 51-4. Adjacent macroblock information buffers 52-1 through 52-4 for transmitting and receiving adjacent macroblock information are provided between the image encoding units 51-1 through 51-4. A memory control unit 53 for allocating memory access and an image encoding unit activation control unit 54 for receiving process macroblock position information from each image encoding unit and performing activation control on each image encoding unit are provided between the image encoding units 51-1 through 51-4 and the memory units 0 through 3. The method of the parallel processing operation of an image encoding unit in the encoding process is similar to that of the image decoding unit in the decoding process. Therefore, the detailed description is omitted here.

The intermediate data buffer, the adjacent macroblock information buffer, the memory control unit, and the image encoding unit activation control unit has a similar function in the encoding process, thereby realizing the parallel processing operation according to the present embodiment.

In the encoder as with the decoder, a chip configuration illustrated in FIG. 17 can be realized.

Thus, in the case in which a plurality of decoding/encoding blocks and a plurality of memory modules are used, the memory bus configuration between the decoding/encoding block and the memory module can be prevented from being complicated and expanded.

In addition, although the number of image decoding/encoding units and memory units increases, the connection between them is limited, thereby simplifying the relationship in arrangement between the I/O terminal and the image decoding/encoding unit.

According to the present embodiment, the reduction effect is greater with an increasing numbers of image decoding units and memory units. Therefore, it is effective in an application in a case in which a larger images are processed, and a large number of image decoding units and memory units are used.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A moving picture decoding apparatus, comprising:
a plurality of image decoding units assigned to each of plural pieces of partial image data obtained by dividing image data into a plurality of image areas, and performing an image decoding process on each of the plural pieces of partial image data;
a plurality of memory units assigned to each of the plural pieces of partial image data and storing each of the plural pieces of partial image data decoded by the plurality of image decoding units; and
a connection device controlling a connection between the plurality of image decoding units and the plurality of memory units.

2. The apparatus according to claim 1, further comprising
an adjacent block buffer storing data of an image decoding unit block adjacent to another image decoding unit block referred to when an image of the other image decoding unit block is decoded.

3. The apparatus according to claim 1, further comprising:
a plurality of variable length decoding units performing a variable length decoding process in picture or slice units; and
an intermediate data buffer storing decoding result data of the plurality of variable length decoding units.

4. The apparatus according to claim 1, wherein
the connection device connects the image decoding unit to one or more memory units.

5. A semiconductor device, comprising:
a plurality of image decoding units assigned to each of plural pieces of partial image data obtained by dividing image data into a plurality of image areas, and performing an image decoding process on each of the plural pieces of partial image data; and
a connection means connected to the plurality of image decoding units, assigned to each of the plural pieces of partial image data, and controlling a connection between a plurality of memory units storing each of the plural pieces of partial image data and the plurality of image decoding units.

6. The apparatus according to claim 5, further comprising:
a control unit controlling a decoding process starting timing so that a reference image area required by decoding process is decoded in the reference images required by the area assigned to each image decoding unit.

7. A moving picture encoding apparatus, comprising:
a plurality of image encoding units assigned to each of plural pieces of partial image data obtained by dividing image data into a plurality of image areas, and performing an image encoding process on each of the plural pieces of partial image data;
a plurality of memory units assigned to each of the plural pieces of partial image data and storing each of the plural pieces of partial image data encoded by the plurality of image encoding units; and
a connection means controlling a connection between the plurality of image encoding units and the plurality of memory units.

8. The apparatus according to claim 7, further comprising:
a control unit controlling an encoding process starting timing so that a reference image area required by encoding process is encoded in the reference images required by the area assigned to each image encoding unit.

9. The apparatus according to claim 7, further comprising
an adjacent block buffer storing block data adjacent to an image encoding unit block referred to when an image of another image encoding unit block is encoded.

10. The apparatus according to claim 7, further comprising:
a plurality of variable length encoding units performing a variable length encoding process in picture or slice units; and
an intermediate data buffer storing encoded data input to the plurality of variable length encoding units.

11. The apparatus according to claim 7, wherein
the connection means further comprises an allocation means allocating access from the image encoding unit to one or more memory units.

12. A semiconductor device, comprising:
a plurality of image encoding units assigned to each of plural pieces of partial image data obtained by dividing image data into a plurality of image areas, and performing an image encoding process on each of the plural pieces of partial image data; and
a connection means connected to the plurality of image encoding units, assigned to each of the plural pieces of partial image data, and controlling a connection between a plurality of memory units storing each of the plural pieces of partial image data and the plurality of image encoding units.
